(19) United States
(12) Patent Application Publication
(10) Pub. No.: US 2012/0250001 A1
(43) Pub. Date: Oct. 4, 2012

(54) STRESS MEASUREMENT DEVICE AND STRESS MEASUREMENT METHOD

(75) Inventor: Yohsuke Tanaka, Kyoto-shi (JP)

(73) Assignee: National University Corporation Kyoto Institute of Technology, Kyoto-shi, Kyoto (JP)

(21) Appl. No.: 13/511,840

(22) PCT Filed: Oct. 27, 2010
(86) PCT No.: PCT/JP2010/069043

§ 371 Date: May 24, 2012

(30) Foreign Application Priority Data
Nov. 27, 2009 (JP) 2009-270501

(51) Int. Cl. G01B 11/16

(52) U.S. Cl. 356/32

(57) ABSTRACT

A stress measurement device is arranged such that image processing is carried out with respect to each of a plurality of particles dispersed in an RP model to which light is emitted, movement directions and movement amounts of the respective plurality of particles in the RP model are found, and a three-dimensional stress occurring in the RP model is measured by use of a result of the finding. The stress measurement device includes: a retaining section which retains the RP model while soaking the RP model in a refractive index matching solution having a refractive index that matches a refractive index of the RP model; and a load application mechanism and a load application mechanism which apply a load to the RP model retained by the retaining section.

### TECHNICAL FIELD

The present invention relates to a stress measurement device and a stress measurement method for measuring a three-dimensional stress in a product, particularly to a stress measurement device and a stress measurement method each of which uses rapid prototyping.

### BACKGROUND ART

Conventional product design verification is exemplified by design verification using three-dimensional CAD and rapid prototyping (hereinafter may be abbreviated as “RP”). Note here that “three-dimensional CAD” refers to a tool for building a three-dimensional model by inputting three-dimensional coordinates. “RP” refers to a technique for rapidly forming a prototype of a product having a design shape.

Commonly, in designing parts to be provided in a body of an automobile or the like, it is necessary to preliminarily verify, at a design stage, not only whether or not the parts can be contained in the body but also an analysis of strain on the body and each of the parts in a collision as an automobile collision safety test.

In view of the circumstances, CAD is commonly used for such designing of a product such as an automobile. In particular, recent widespread use of three-dimensional CAD allows an improvement in workability since a designer can view a three-dimensional image on a computer screen. In addition, recent widespread use of RP allows a designer to prepare a three-dimensional model having a shape of a target object in a much shorter time without the need of preparing a prototype by use of actual parts. This has dramatically improved convenience and accuracy of design verification.

An already-known RP device for preparing a prototype formed by RP (hereinafter may be simply referred to as an “RP model”) is exemplified by a stereolithography apparatus which causes laser light or ultraviolet light to cure a liquid resin based on three-dimensional CAD data.

A technique for using a publicly-known photoelasticity method is suggested for a case (e.g., an analysis of strain on a body and each of parts in a collision (described earlier)) where a three-dimensional stress in a product is measured by use of such an RP model (see Non Patent Literature 1, for example).

The photoelasticity method is one of effective techniques in a stress analysis. According to the photoelasticity method, an external force is applied to an RP model, so that a state of a stress field occurring inside the RP model can be measured.

According to this method, an RP model is formed by use of a photoelastic material which has a characteristic of causing double refraction by application of an external force. Then, the RP model is left to stand for a given time and at a given temperature with a given load applied thereto (this process is referred to as “Process 1”).

Next, the RP model is cut into a plurality of plate-like layers, so as to measure a stress field in each of the plurality of plate-like layers by use of a publicly-known photoelasticity measurement device (this process is referred to as “Process 2).

Finally, a stress field inside the RP model can be three-dimensionally obtained by substituting a two-dimensional stress field in the each of the plurality of plate-like layers for an elastodynamic governing equation.

However, according to the above technique, in order to measure a change in stress field which changes every moment in accordance with a load, it is necessary to repeat, many times for each given time, the Process 1 and the Process 2 as described earlier.

Namely, the above technique has a problem such that enormous time and manpower is required for measurement of a change over time in three-dimensional stress field in a product.

This problem serves as a critical defect in realization of higher-speed product development.

In contrast, an adhering method and an adhering device have been suggested and are arranged as below (see Patent Literature 1, for example). Many particles are mixed in an adhesive, and a movement of those particles is detected, so as to visualize a flow of the particles due to shrinkage on curing in the adhesive. Then, an adhesion quality is improved by, for example, detecting a curing state of the adhesive and/or positioning energy irradiation with respect to a curing target position in the adhesive. This allows (i) prevention of an adhesion failure at a boundary between the adhesive and an adherend, (ii) a reduction in residual stress due to shrinkage on curing in the adhesive, (iii) an improvement in accuracy of positioning for curing the adhesive on the adherend, and (iv) a reduction in change over time in adhesive.

According to the adhering method and the adhering device, an objective lens is used in which a detection target particle mixed in the adhesive or a region is focused, so as to cause a two-dimensional CCD camera to record an image of the particle or the region. A temporal positional change in particle is viewed as an image by obtaining a plurality of images by carrying out image recording a plurality of times on a time-series basis.

This allows high-speed detection of a change over time in residual stress due to curing of the adhesive.

However, according to the adhering method and the adhering device, the adhesive which serves as an object to be measured and the surrounding atmospheric gas (normally, air) differ in refractive index.

Therefore, scattered light having entered the surrounding atmospheric gas from the adhesive is refracted due to a difference, at a boundary between the adhesive and the surrounding atmospheric gas, in refractive index therebetween. This causes a problem such that the two-dimensional CCD camera cannot accurately record an image of the scattered light.

This problem causes a large reduction in accuracy of the image recording by the two-dimensional CCD camera especially in a case where the object to be measured has a complicated shape. This is because the refraction of the scattered light due to the difference, at the boundary between the object to be measured and its surroundings, in refractive index therebetween overlaps the complicated shape.

### CITATION LIST

### Patent Literature

### Patent Literature 1

Japanese Patent Application Publication, Tokukai, No. 2005-350524 A (Publication Date: Dec. 22, 2005)

### Non Patent Literature

### Non Patent Literature 1

Robertson, K.: Photoelastic stress analysis, John Wiler & Sons, (1977), 362-367.

### SUMMARY OF INVENTION

### Technical Problem

In view of the problems, an object of the present invention is to provide a stress measurement device and a stress measurement method each of which is capable of measuring a change over time in three-dimensional stress with high accuracy even in a case where an RP model having a complicated shape is used to measure a three-dimensional stress by use of rapid prototyping (RP).

### Solution to Problem

In order to attain the object, a stress measurement device in accordance with the present invention in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding, the stress measurement device includes: a retaining section which retains the light-transmissive member while soaking the light-transmissive member in a refractive index matching solution having a refractive index that matches a refractive index of the light-transmissive member; and a load application mechanism which applies a load to the light-transmissive member retained by the retaining section.

Note here that the application of the load to the light-transmissive member by the “load application mechanism” realizes, in the light-transmissive member, a distribution of various stresses such as a compressive stress, a shearing stress, and a bending stress.

According to the stress measurement device, it is possible to apply the load to the light-transmissive member while soaking, in the refractive index matching solution having a refractive index that matches a refractive index of the light-transmissive member, the light-transmissive member which is subjected to a stress measurement.

This makes it possible to measure the three-dimensional stress in the light-transmissive member to which the load is applied while preventing refraction of light at a boundary between the light-transmissive member and the refractive index matching solution. Therefore, a change over time in three-dimensional stress in the light-transmissive member can be measured with high accuracy.

A stress measurement method in accordance with the present invention in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding, the stress measurement method includes the steps of: (a) retaining the light-transmissive member while soaking the light-transmissive member in a refractive index matching solution having a refractive index that matches a refractive index of the light-transmissive member; and (b) measuring a change over time in three-dimensional stress occurring in the light-transmissive member, while applying a load to the light-transmissive member soaked in the refractive index matching solution.

According to the stress measurement method, it is possible to apply the load to the light-transmissive member while soaking, in the refractive index matching solution having a refractive index that matches a refractive index of the light-transmissive member, the light-transmissive member which is subjected to a stress measurement.

This makes it possible to measure the three-dimensional stress in the light-transmissive member to which the load is applied while preventing refraction of light at a boundary between the light-transmissive member and the refractive index matching solution. Therefore, a change over time in three-dimensional stress in the light-transmissive member can be measured with high accuracy.

### Advantageous Effects of Invention

As described earlier, a stress measurement device in accordance with the present invention in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding, the stress measurement device includes: a retaining section which retains the light-transmissive member while soaking the light-transmissive member in a refractive index matching solution having a refractive index that matches a refractive index of the light-transmissive member; and a load application mechanism which applies a load to the light-transmissive member retained by the retaining section.

As described earlier, a stress measurement method in accordance with the present invention in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding, the stress measurement method includes the steps of: (a) retaining the light-transmissive member while soaking the light-transmissive member in a refractive index matching solution having a refractive index that matches a refractive index of the light-transmissive member; and (b) measuring a change over time in three-dimensional stress occurring in the light-transmissive member, while applying a load to the light-transmissive member soaked in the refractive index matching solution.

This yields an effect of measuring a change over time in three-dimensional stress with high accuracy even in a case where an RP model having a complicated shape is used to measure a three-dimensional stress by use of rapid prototyping (RP).

### BRIEF DESCRIPTION OF DRAWINGS

FIG. 1 illustrates a schematic arrangement of a stress measurement device in accordance with an embodiment of the present invention.

FIG. 2 is a conceptual view for describing an RP model and a refractive index matching solution which are used for the stress measurement device.

FIG. 3 is a cross-sectional view showing a specific example of the RP model.

FIG. 4 is a conceptual view for describing how an image processing device provided in the stress measurement device records and reproduces a digital holographic image.

FIG. 5 is a conceptual view (Part 1) for describing a process carried out by the image processing device from recording of a digital holographic image to derivation of a three-dimensional stress field.

FIG. 6 is a conceptual view (Part 2) for describing a process carried out by the image processing device from recording of a digital holographic image to derivation of a three-dimensional stress field.

FIG. 7 illustrates a schematic arrangement of a stress measurement device in accordance with another embodiment of the present invention.

FIG. 8 is a conceptual view for describing an RP model and a stirred solution which are used for the stress measurement device.

FIG. 9 is a cross-sectional view showing a specific example of the RP model.

FIG. 10 illustrates image data of tracer particles dispersed in the RP model.

FIG. 11 illustrates image data of stirred solution reference light and stirred solution object light each having exited from the stirred solution, the image data having been recorded by the image processing device.

FIG. 12 illustrates image data of RP model reference light and RP model object light each having exited from the RP model, the image data having been recorded by the image processing device.

FIG. 13 is a graph for describing a template which is used for a particle mask correlation method.

FIG. 14 illustrates (i) image data in which a region indicated by C in each of FIGS. 8 and 9 is seen from a y direction and (ii) image data in which the region indicated by C is seen from a z direction.

### DESCRIPTION OF EMBODIMENTS

### First Embodiment

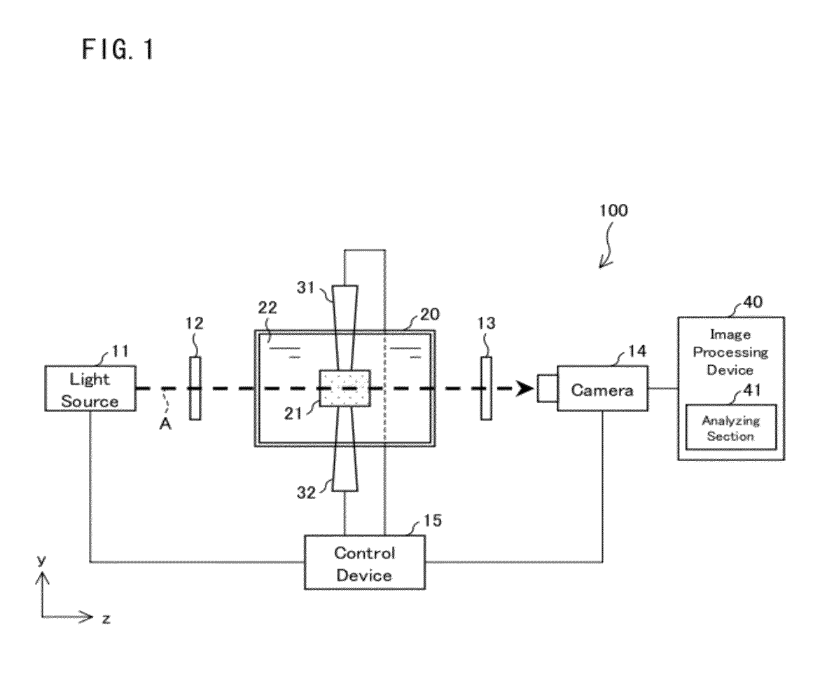

An embodiment of the present invention is described below with reference to FIGS. 1 through 6.

(Principle of Stress Measurement)

A stress measurement device in accordance with an embodiment of the present invention uses an RP model formed by three-dimensional CAD and an RP technique, so as to measure a stress field inside the RP model. In particular, the stress measurement device in accordance with the embodiment of the present invention is capable of measuring a change over time in stress field occurring inside the RP model while applying a load to the RP model.

Note that the three-dimensional CAD is general-purpose CAD which forms a three-dimensional model of a target object. The three-dimensional model formed by the three-dimensional CAD can faithfully reproduce a contour of the target object as a solid model. Any technique that is well known in this industry is applicable to such CAD regardless of a name thereof.

The RP technique is a technique for rapidly forming an RP model having a shape of a target object which shape corresponds to input data. The RP technique is implemented by use of, for example, a stereolithography apparatus which causes laser light or ultraviolet light to cure a liquid resin. Any technique that is well known in this industry is applicable to such an RP technique.

According to the embodiment of the present invention, the RP model is made of a light-transmissive transparent material. It is preferable to use, as the transparent material, a transparent resin such as acryl. Not to mention, the present invention is not limited to such a resin. In short, it is only necessary that the transparent material be a photoelastic material which has a characteristic of causing no double refraction by application of an external force.

Many tracer particles (particles) are uniformly dispersed in the RP model. Each of these tracer particles follows a displacement of each part of the RP model in which part the each of the tracer particles is contained, and moves together with the each part.

First, the following description briefly discusses many tracer particles to be dispersed in an RP model.

Research on a technique for visualization in a flow field has recently been advanced. As an example of a universal velocity measurement technique to which an image processing technique is applied, Particle Image Velocimetry (hereinafter referred to as “PIV”) has been developed which is capable of highly accurately and precisely measuring a velocity of a fluid in a complicated flow field by use of an image processing technique.

Many of such PIVs using an image processing technique are based on the following principle: Tracer particles are mixed in a flow, and a movement of the tracer particles are traced by directing pulse laser light to the tracer particles which sufficiently follow the flow. Then, an image of a movement of a tracer particle group is recorded by a video camera or the like. An image of a movement distance for which the tracer particle group has moved in a sufficiently shorter time interval than a time scale of the flow is found and a velocity is found by dividing the movement distance thus found by a minute image recording time interval.

The PIV measures an average fluid velocity within a given area in which a plurality of tracer particles exist. Therefore, an increase in number of tracer particles allows setting of spatially uniform measurement points. Therefore, the PIV has an advantage of easily obtaining a spatial differential of a velocity. In view of these reasons, it can be said that the PIV is extremely effective means for measuring a velocity or a vorticity necessary for extraction of an organizational structure of a flow field.

Such a PIV analysis is specifically described in, for example, “PIV handbook” by The Visualization Society of Japan, published by Morikita Publishing Co., Ltd., Jul. 20, 2002.

The stress measurement device in accordance with the embodiment of the present invention uses such a PIV analysis to measure a change over time in stress field occurring inside an RP model.

Namely, according to the embodiment of the present invention, many tracer particles are dispersed in an RP model in advance. Those many tracer particles are located at their respective fixed positions inside the RP model without moving inside the RP model. It is preferable that as many tracer particles as possible be uniformly dispersed in the RP model. Note here that the term “uniformly” in “uniformly dispersed” encompasses not only a case of perfect uniformity but also a case of substantial uniformity. Specifically, assume that a relative movement distance pᵣ expressed by the following equation is used as an indicator of a degree with which tracer particles are dispersed in an RP model. In a case where 0<pᵣ<1, it can be said that the tracer particles are uniformly dispersed.

$${ρ}_{r} = {r}_{max} \sqrt[3]{\frac{{N}_{o} π}{{V}_{o}}} \qquad [ Math . 1 ]$$

Pr: Relative movement distance (dimensionless quantity)
rₘₐₓ: Maximum movement distance (pixel)
Nₒ: Number of particles in hologram reproduction volume
Vₒ: Size of region through which certain particle may move before subsequent time

$$( \frac{4}{3} π {r}_{max}^{3} )$$

In the above equation, in a case where the relative movement distance pᵣ is not less than 1, it is difficult to trace the tracer particles by associating particle images with the respective tracer particles. Therefore, it is necessary that pᵣ<1. In contrast, given that each of rₘₐₓ (a maximum movement distance), Nₒ (the number of particles in a hologram reproduction volume), Vₒ (a size of a region through which a certain particle may move before a subsequent time), and π is a positive value in the above equation, it can be derived that 0<pᵣ.

Note that the embodiment of the present invention discusses an example such that many tracer particles are uniformly dispersed in an RP model. However, the present invention is not limited to this.

For example, more tracer particles may be dispersed in a measurement target part inside an RP model than in a part of the RP model other than the measurement target part, i.e., tracer particles may be locally concentrated in the measurement target part.

This allows an increase in number of measurement points in a part in which the tracer particles are dispersed so as to be locally concentrated. Therefore, it is possible to enhance a measurement accuracy of the measurement target part.

In a case where a load is applied to such an RP model, a displacement occurs in each part of the RP model in accordance with the application of the load. A tracer particle in the each part of the RP model moves together with the each part.

Accordingly, a displacement of each part of an RP model can be observed by tracing a movement of each of many tracer particles dispersed in the RP model.

Therefore, the stress measurement device in accordance with the embodiment of the present invention uses an RP model in which many tracer particles are thus dispersed. Then, the stress measurement device finds, in accordance with the PIV analysis, a velocity of each of the many tracer particles dispersed in the RP model while applying a load to the RP model.

The velocity of the each of the many tracer particles thus found indicates a velocity of each part of the RP model. As a result, it is possible to measure a movement distance and a movement direction of the each part of the RP model.

Based on a result thus measured, the stress measurement device in accordance with the embodiment of the present invention measures a change over time in stress field occurring inside the RP model.

(Stress Measurement Device 100)

Next, the following description discusses a stress measurement device 100 in accordance with the embodiment of the present invention. The stress measurement device 100 is a three-dimensional measurement device employing an in-line holographic image recording system using one (1) camera.

Note that the present invention is not limited to the embodiment of the in-line holographic image recording system using one (1) camera. For example, the present invention may be a stereo method in which a stress measurement is carried out by a principle of triangulation by arranging a plurality of cameras. Such a stereo method may be exemplified by an in-line stereo method in which a stress measurement is carried out by arranging a plurality of cameras on an identical optical axis or an off-axis stereo method in which a stress measurement is carried out by arranging a plurality of cameras on different optical axes.

The following description shows an example such that light emitted from a light source becomes object light by being diffracted by tracer particles. However, the present invention is not limited to this. Light emitted from a tracer particle itself may become object light.

FIG. 1 illustrates a schematic arrangement of the stress measurement device 100 in accordance with the embodiment of the present invention. The stress measurement device 100 includes a light source 11, a first optical system 12, a second optical system 13, a camera 14, a control device 15, a retaining section 20, a load application mechanism 31 and a load application mechanism 32, and an image processing device 40 (see FIG. 1).

For example, a laser light source which emits laser light can be used for the light source 11. In this case, the laser light source may be CW laser or pulse laser. However, in order to sufficiently secure an intensity of object light from tracer particles (described later), it is preferable to use a laser light source which allows obtainment of a high output. In FIG. 1, for viewability of the drawing, only an optical path of laser light emitted from the light source 11 is shown by an arrow indicated by A in FIG. 1.

Note that the following description discusses a case where a laser light source is used for the light source 11. However, the present embodiment is not limited to this. Laser light may be replaced with ultrasonic waves, X-rays, light from an LED, light from a super luminescent diode, light from a halogen lamp, light from a xenon lamp, light from a mercury lamp, light from a sodium lamp, microwaves, terahertz waves, electron beams, or radio waves.

The first optical system 12 collimates laser light emitted from the light source 11. For example, it is only necessary to use a collimate lens for the first optical system 12. The laser light emitted from the light source is uniformly diffused by passing through the first optical system 12 constituted by such a collimate lens, so as to be collimated. The laser light thus collimated is directed to the retaining section 20.

The retaining section 20 contains an RP model which serves as a measurement target to be subjected to a stress measurement by the stress measurement device 100. The retaining section 20 contains an RP model (light-transmissive member) 21. The retaining section 20 is filled with a refractive index matching solution 22. The RP model 21 is contained in the retaining section 20 while being entirely soaked in the refractive index matching solution 22.

Each of the retaining section 20 and the refractive index matching solution 22 which fills the retaining section 20 transmits the laser light emitted from the light source 11. Therefore, after passing through the first optical system 12, the laser light emitted from the light source 11 passes through a side wall of the retaining section 20 and the refractive index matching solution 22 in this order and then enters the RP model 21.

Many tracer particles are dispersed in the RP model as described later. The laser light having entered the RP model 21 is diffracted by the many tracer particles inside the RP model 21, so that a first laser light having been diffracted and a second laser light not having been diffracted exit from the RP model 21. In this case, the second laser light not having been diffracted serves as reference light. As a result, the reference light and object light which is the first laser light having been diffracted interfere with each other.

The laser light having exited from the RP model 21, i.e., each of the object light and the reference light passes through the refractive index matching solution 22 and the side wall of the retaining section 20 in this order and then enters the second optical system 13.

As in the case of the first optical system 12, a collimate lens, for example can be used for the second optical system 13. The second optical system 13 collimates, again, the laser light (the object light and the reference light) having exited from the retaining section 20 and causes the laser light thus collimated to enter the camera 14. For example, a combination of a plurality of collimate lenses may be used for the second optical system 13.

For example, a publicly-known camera such as a CCD camera, a high-speed CCD camera, an EMCCD camera, an IICCD camera, or a CMOS camera can be used for the camera 14 (image recording section). Image data recorded by the camera 14 is supplied to the image processing device 40, so that a moving distance and a moving direction of a tracer particle inside the RP model 21 are found in accordance with such image data.

As described earlier, the laser light having exited from the RP model 21 contains the object light and the reference light, which interfere with each other. As a result, the camera 14 records digital holographic images of the respective many tracer particles inside the RP model 21.

The camera 14 records, as, for example, digital data, the digital holographic images thus recorded, so as to supply the digital data to the image processing device 40.

The image processing device 40 carries out a three-dimensional image process in accordance with the digital holographic images recorded by the camera 14. The image processing device 40 includes an analyzing section 41. For each of the many tracer particles inside the RP model 21, the analyzing section 41 carries out a three-dimensional PIV analysis with respect to the digital holographic images recorded by the camera 14.

In accordance with the three-dimensional PIV analysis carried out by the analyzing section 41, the image processing device 40 finds, from, for example, the digital holographic images recorded at a time t0, three-dimensional positions of the respective many tracer particles at the time t0. Similarly, the image processing device 40 finds, from, for example, the digital holographic images recorded at a time t0+Δt, three-dimensional positions of the respective many tracer particles at the time t0+Δt. Velocity vectors of the respective many tracer particles can be found by dividing, by Δt, a difference in three-dimensional position at each time.

The image processing device 40 uses the velocity vectors thus found of the respective many tracer particles inside the RP model 21 to measure a change over time in stress field inside the RP model 21 from the time t0 to the time t0+Δt.

The load application mechanism 31 and the load application mechanism 32 apply a load to the RP model contained in the retaining section 20. The load application mechanism 31 and the load application mechanism 32 can realize, in the RP model 21, a distribution of various stresses such as a compressive stress, a shearing stress, and a bending stress by adjusting how to apply the load to the RP model 21.

The load application mechanism 31 and the load application mechanism 32 support, in a vertical direction thereof (y-axis direction in FIG. 1), the RP model 21 which is contained in the retaining section 20 while being soaked in the refractive index matching solution 22. In such a situation, the load application mechanism 31 applies the load to the RP model 21 in a downward direction (negative direction of a y-axis in FIG. 1), whereas the load application mechanism 32 applies the load to the RP model 21 in an upward direction (positive direction of the y-axis in FIG. 1).

The control device 15 is electrically connected to each of the light source 11, the camera 14, and the load application mechanism 31 and the load application mechanism 32 so that various control signals can be exchanged between the control device 15 and each of the light source 11, the camera 14, and the load application mechanism 31 and the load application mechanism 32. The control device 15 controls, for example, a drive operation of the light source 11, an image recording operation of the camera 14, and a load application operation of the load application mechanism 31 and the load application mechanism 32.

It is only necessary that the control device 15 synchronize, for example, a timing at which the laser light from the light source 11 is emitted, a timing at which the load application mechanism 31 and the load application mechanism 32 apply the load, and a timing at which the camera 14 carries out image recording.

(RP Model 21 and Refractive Index Matching Solution 22)

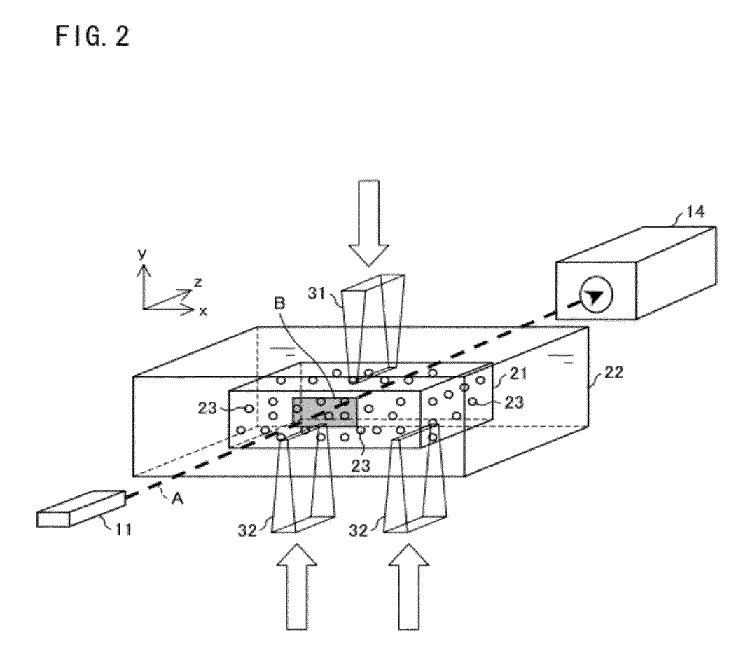

Next, the following description discusses the RP model 21 and the refractive index matching solution 22. FIG. 2 is a conceptual view for describing the RP model 21 and the refractive index matching solution 22. In FIG. 2, for viewability of the drawing, only an optical path of laser light emitted from the light source 11 is shown by an arrow indicated by A in FIG. 2. Note that an area indicated by B in FIG. 2 is a region of the RP model 21 to which region the laser light emitted from the light source 11 is directed.

Many tracer particles 23 are dispersed in the RP model 21 (see FIG. 2). Note that a type, etc. of a tracer particle 23 is not particularly limited in the present invention. The type, etc. is appropriately selected in accordance with a type, etc. of a photoelastic material of which the RP model 21 is made.

As described earlier, the RP model 21 is contained in the retaining section 20, and the retaining section 20 is filled with the refractive index matching solution 22. In other words, the refractive index matching solution 22 surrounds the RP model 21 (see FIG. 2).

The refractive index matching solution 22 has a refractive index which matches a refractive index of the photoelastic material of which the RP model 21 is made. Specifically, the refractive index matching solution 22 is substantially identical in refractive index to the photoelastic material of which the RP model 21 is made.

Note that, in a case where the photoelastic material of which the RP model 21 is made and the refractive index matching solution 22 differ in refractive index by approximately 1%, it can be said that the photoelastic material of which the RP model 21 is made and the refractive index matching solution 22 are substantially identical in refractive index.

In a case where the RP model 21 and the refractive index matching solution 22 are identical in refractive index, a difference in refractive index at a boundary between the RP model 21 and the refractive index matching solution 22 can be resolved.

This prevents the laser light emitted from the light source 11 from being refracted at the boundary between the refractive index matching solution 22 and the RP model 21 when the laser light passes through the refractive index matching solution 22 and the RP model 21 in this order.

Further, neither the object light having been diffracted by the many tracer particles 23 inside the RP model 21 nor the reference light not having been diffracted by the many tracer particles 23 is refracted at the boundary between the RP model 21 and the refractive index matching solution 22 when the object light and the reference light enters the refractive index matching solution 22 from the RP model 21.

Accordingly, the laser light emitted from the light source 11 enters the RP model 21 without being refracted at the boundary between the refractive index matching solution 22 and the RP model 21. Then, each of the object light having been diffracted inside the RP model 21 and the reference light not having been diffracted inside the RP model 21 enters the index matching solution 22 without being refracted at the boundary between the refractive index matching solution 22 and the RP model 21.

Therefore, the camera 14 can accurately record an image of each of the object light having been diffracted by the many tracer particles 23 inside the RP model 21 and the reference light not having been diffracted by the many tracer particles 23.

As the RP model 21 has a more complicated shape, a difference in refractive index between the RP model 21 and its surroundings causes the laser light which passes through a boundary between the RP model 21 and its surroundings to be more highly refracted. This increases a degree with which the camera 14 is prevented from accurately carrying out image recording.

According to the stress measurement device 100 in accordance with the embodiment of the present invention, the above problems can be solved by causing the refractive index matching solution 22 which is identical in refractive index to the RP model 21 to surround the RP model 21.

(Example)

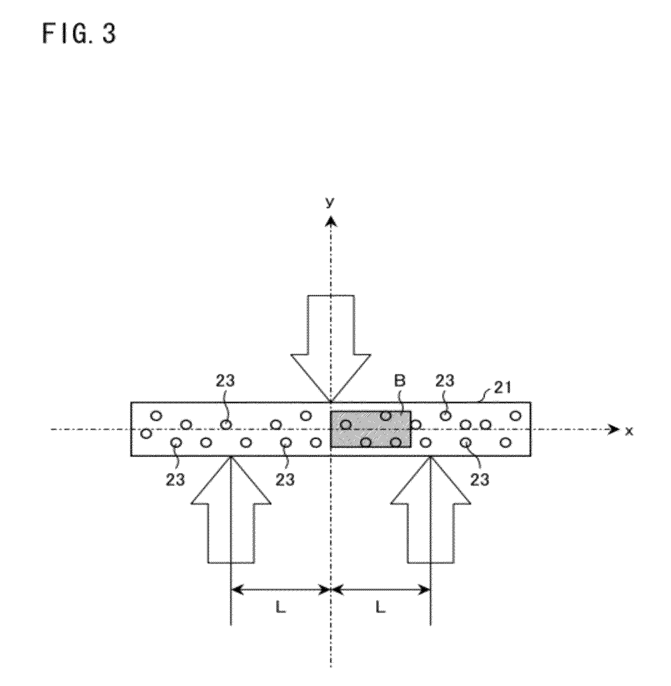

Next, the following description discusses an example of the RP model 21 and the refractive index matching solution 22. FIG. 3 is a cross-sectional view showing a specific example of the RP model 21.

In the example shown in FIG. 3, the RP model 21 is made of a light-transmissive acrylic resin (refractive index: 1.4883, elastic coefficient: 3317 Mpa). The light-transmissive acrylic resin has a size of 7.9×50×7.9 mm³.

As described earlier, according to the load application mechanism 31 and the load application mechanism 32 which apply the load to the RP model 21, two load application mechanisms 32 support the RP model 21, and one (1) load application mechanism 31 applies a pressure (load) to a vicinity of a central point in a longitudinal direction (x-axis direction in FIG. 3) of the RP model. Each of points at which the respective two load application mechanisms 32 support the RP model 21 is away, by a distance L (=15 mm), from the central point of the RP model 21.

According to the present example, the load application mechanism 31 applies a pressure of 100 N.

The many tracer particles 23 have an average diameter of 60 μm.

The refractive index matching solution 22 is a sodium iodide solution which is identical in refractive index to the acrylic resin of which the RP model 21 is made.

As described earlier, before and after the application of the pressure (load), three-dimensional positions of the respective many tracer particles 23 inside the RP model 21 are measured, so as to find velocity vectors of the respective many tracer particles before and after the application of the pressure (load).

(Image Processing Device 40)

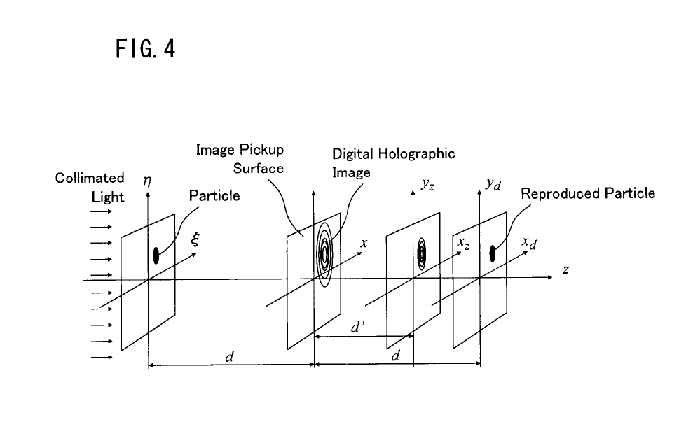

Next, the following description discusses image processing carried out by the image processing device 40. First, the following description discusses how the image processing device 40 records and reproduces a digital holographic image recorded by the camera 14. FIG. 4 is a conceptual view for describing how the image processing device 40 records and reproduces a digital holographic image.

A ξ-η plane shows coordinates of a particle (tracer particle 23) existing in a three-dimensional space in the RP model 21 (see FIG. 4).

Object light having been diffracted by the particle (tracer particle 23) and reference light not having been diffracted by the particle (tracer particle 23) are recorded as a light intensity I_{d} (x, y, 0) in an image recording surface of the camera 14. Note that the image recording surface of the camera 14 is located in an x-y plane which is away, by a distance d, from the particle (tracer particle 23) in the ξ-η plane.

Next, a light amplitude field h_{z} (x_{z}, y_{z}) at any position on a z-axis z=d′ can be expressed by the following equation.

$$[ Math . 2 ]$$

$${h}_{z} ( {x}_{z} , {y}_{z} ) = \frac{1}{j λ} {\int }_{- ∞}^{∞} {\int }_{- ∞}^{∞} {I}_{d} ( x , y , 0 ) \frac{exp ( j \frac{2 π L}{λ} )}{L} d ξ d η \qquad ( 1 )$$

Note here that j indicates an imaginary unit and λ indicates a wavelength of laser light. Note also that L, which indicates a distance between corresponding two points between the x-y plane and an x_{z}-y_{z} plane, is expressed by the following equation.

[Math. 3]

L=\sqrt{d²+(x_{z}−x)²+(y_{z}−y)²} (2)

A light intensity I_{z} (x_{z}, y_{z}) is found based on the following equation.

[Math. 4]

I_{z}=h_{z}h_{z}* (3)

The particle (tracer particle 23) is thus reproduced in an x_{d}-y_{d} plane which is away, by the distance d, from the x-y plane.

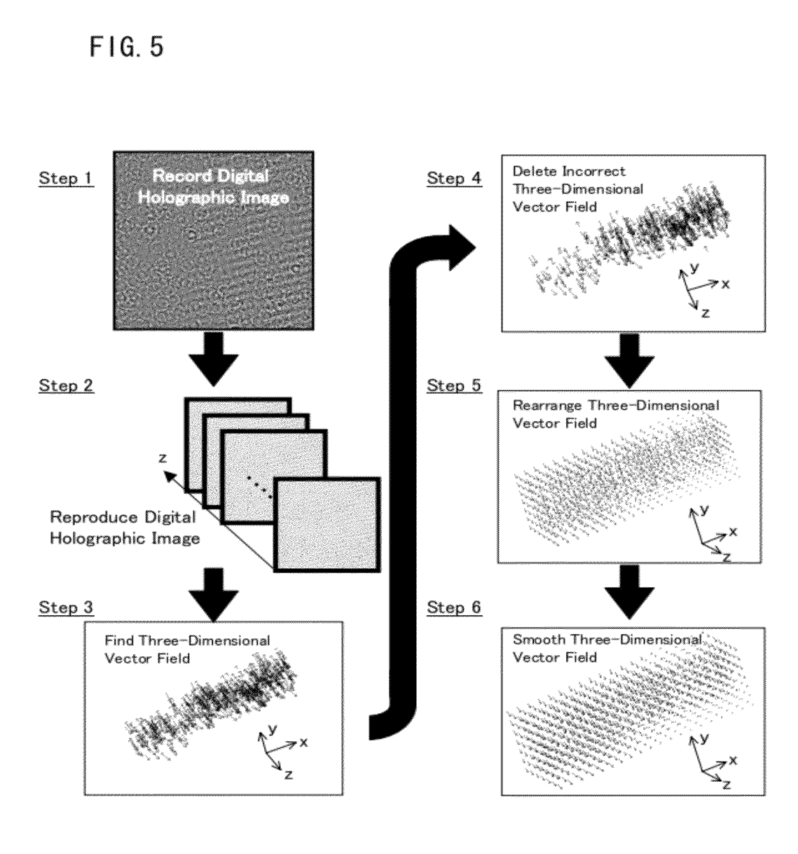

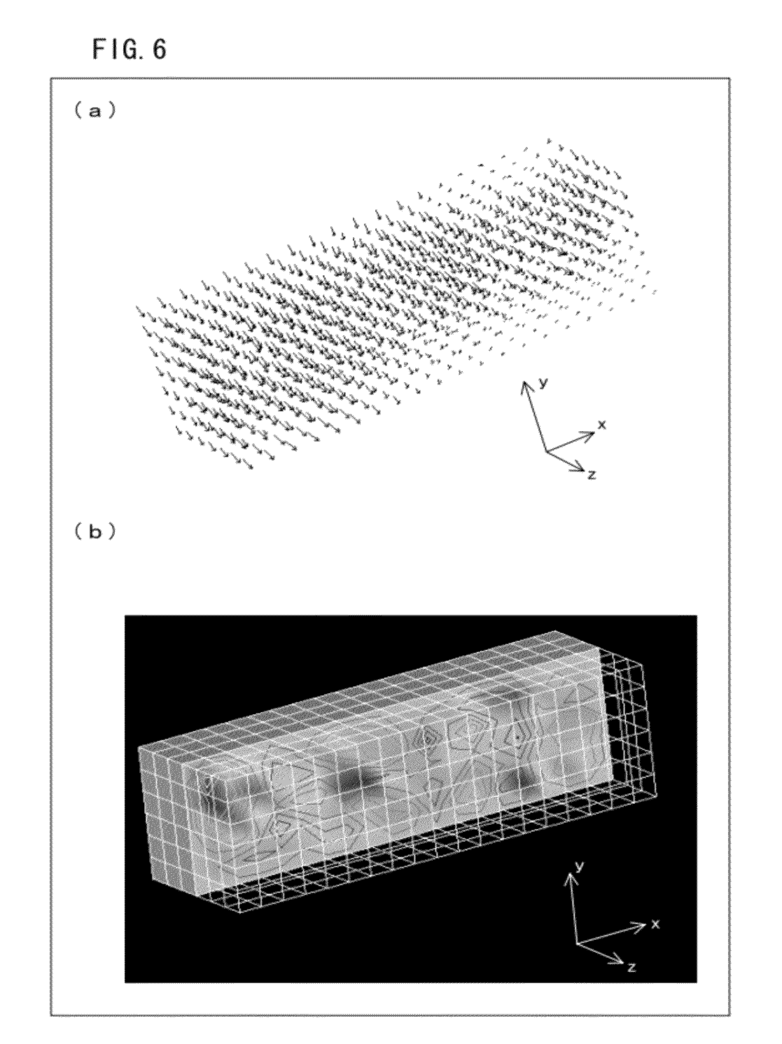

Next, the following description discusses a process carried out by the image processing device 40 from recording of a digital holographic image recorded by the camera 14 to derivation of a three-dimensional stress field. Each of FIGS. 5 and 6 is a conceptual view for describing the process carried out by the image processing device 40 from recording of a digital holographic image to derivation of a three-dimensional stress field.

First, before and after the application of the load to the RP model 21 by the load application mechanism and the load application mechanism 32, digital holographic images recorded by the camera 14 are recorded (Step 1) (see FIG. 5).

As described earlier, the digital holographic images are reproduced, and three-dimensional positions of the respective many tracer particles 23 are detected (Step 2).

Three-dimensional vector fields of the respective many tracer particles 23 before and after the application of the load are found (Step 3).

Incorrect three-dimensional vector fields are deleted (Step 4).

The three-dimensional vector fields are rearranged (Step 5).

The three-dimensional vector fields thus rearranged are smoothed (Step 6).

Based on the following equation, three-dimensional displacement fields are found from the three-dimensional vector fields thus obtained before and after the application of the load to the RP model 21.

ε(εx,εy,εz)=∂U/∂x=(∂u/∂x,∂v/∂y,∂w/∂z) (4)

Based on the following equation, three-dimensional stress fields (see (b) of FIG. 6) are found from the three-dimensional displacement fields (see (a) of FIG. 6) obtained based on the equation (4) (see FIG. 6).

σ(σx,σy,σz)=E·ε=(E·εx,E·εy,E·εz) (5)

The image processing device 40 thus finds the three-dimensional stress fields before and after the application of the load to the RP model 21.

### Second Embodiment

Next, the following description discusses a second embodiment of the present invention. According to the First Embodiment, many tracer particles are dispersed in, for example, a structure such as an automobile body and various parts to be contained in the automobile body, and displacements, i.e., movement directions and movement amounts of the respective many tracer particles are traced, so that a three-dimensional stress in the structure is measured. Note that the structure is an object formed by combining various members so that the object can resist a load such as an external force.

In contrast, the Second Embodiment of the present invention is an embodiment such that a change over time in three-dimensional stress in the structure and a change over time in three-dimensional velocity of a fluid are measured concurrently in a three-dimensional space in which the structure and the fluid exist concurrently.

Specifically, as in the case of the First Embodiment, according to the Second Embodiment of the present invention, many tracer particles are dispersed in the structure. Further, many tracer particles are dispersed also in the fluid. Note, however, that a tracer particle to be dispersed in the structure and a tracer particle to be dispersed in the fluid differ in particle size.

Namely, according to the Second Embodiment of the present invention, two types of particles which differ in particle size as described above are dispersed in the structure and the fluid, respectively. The stress measurement device and the stress measurement method of the First Embodiment are applied to each of these two types of tracer particles. A change over time in three-dimensional stress is measured for the structure, whereas a change over time in three-dimensional velocity is measured for the fluid.

A change over time in three-dimensional velocity of the fluid can be measured by tracing displacements of the respective many tracer particles as in the case of the First Embodiment. Since the structure has a fixed shape, a stress occurs inside the structure when a load is applied to the structure. In contrast, the fluid, which is a transformable body, flows/transforms in a direction in which a load is applied. Accordingly, for the structure, a displacement of a tracer particle refers to a change over time in three-dimensional stress in the structure, whereas for the fluid, a displacement of a tracer particle refers to a change over time in three-dimensional velocity of the fluid.

Note that the Second Embodiment of the present invention is not limited to a three-dimensional space in which a structure and a fluid exist concurrently (described earlier). For example, according to the Second Embodiment, changes over time in three-dimensional stress in respective two or more structures can be measured in a three-dimensional space in which the two or more structures interact with each other (e.g., apply loads to each other).

The following description discusses the embodiment such that a change over time in three-dimensional stress in the structure and a change over time in three-dimensional velocity of a fluid are measured concurrently in a three-dimensional space in which the structure and the fluid exist concurrently (described earlier).

(Stress Measurement Device 100a)

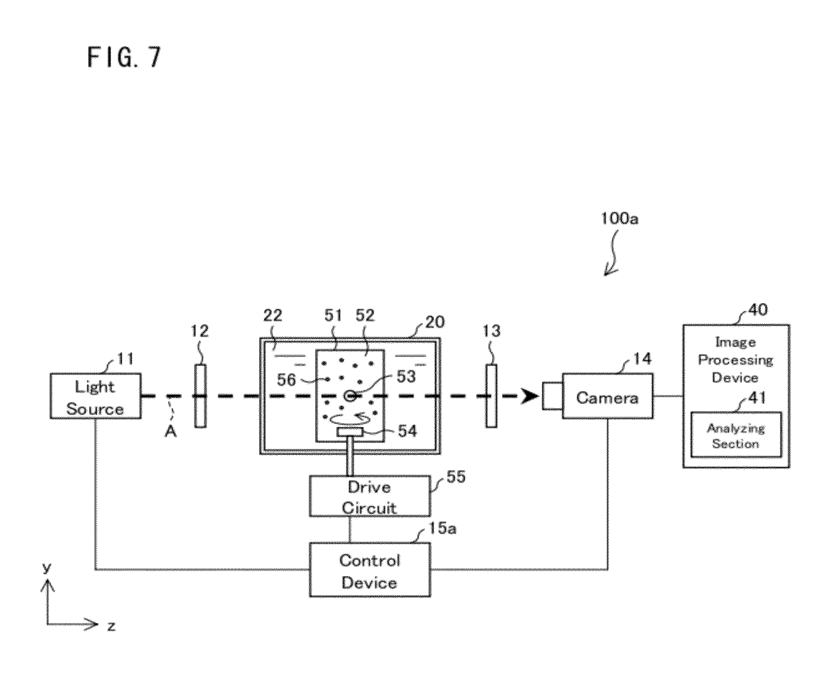

FIG. 7 illustrates a schematic arrangement of a stress measurement device 100a in accordance with the Second Embodiment of the present invention. In the following description, parts identical to those of the First Embodiment are given respective identical reference numerals, and a specific description of those parts is to be omitted.

The stress measurement device 100a includes a light source 11, a first optical system 12, a second optical system 13, a camera 14, a control device 15a, a retaining section 20, and an image processing device 40 (see FIG. 7).

The retaining section 20 includes a sealed container 51, a stirred solution 52 which fills the sealed container 51 and is stirred, an RP model (light-transmissive member) 53 which is fixed to an inner wall of the sealed container 51, and a stirring member 54 for stirring the stirred solution 52 contained in the sealed container 51.

The sealed container 51 contains (i) the RP model which serves as the structure mentioned above which is subjected to a stress measurement by the stress measurement device 100a and (ii) the stirred solution 52 which serves as the fluid mentioned above which is subjected to a velocity measurement by the stress measurement device 100a. The RP model 53 is contained in the sealed container 51 while being entirely soaked in the stirred solution 52.

Each of the sealed container 51 and the stirred solution 52 which fills the sealed container 51 transmits laser light emitted from the light source 11. Therefore, after passing through the first optical system 12, the laser light emitted from the light source 11 passes through a side wall of the retaining section 20, a refractive index matching solution 22, and a side wall of the sealed container 51 in this order and then enters the stirred solution 52 and the RP model 53.

As in the case of the First Embodiment, many tracer particles are dispersed in the RP model 53. The laser light having entered the RP model 53 is diffracted by the many tracer particles inside the RP model 53, so that a first laser light having been diffracted and a second laser light not having been diffracted exit from the RP model 53. In this case, the second laser light not having been diffracted serves as reference light. As a result, the reference light and object light which is the first laser light having been diffracted interfere with each other. The reference light and the object light are used for tracing a displacement of a tracer particle inside the RP model 53. The following description refers to the reference light and the object light each of which is used for tracing a displacement of a tracer particle inside the RP model 53 as “RP model reference light” and “RP model object light”, respectively.

The laser light having exited from the RP model 53, i.e., each of the RP model object light and the RP model reference light passes through the stirred solution 52, the side wall of the sealed container 51, the refractive index matching solution 22, and the side wall of the retaining section 20 in this order and then enters the second optical system 13. Note that a part of each of the RP model object light and the RP model reference light may be diffracted again by a tracer particle 56 inside the stirred solution 52. In this case, light thus diffracted is not used for tracing a displacement of a tracer particle inside the RP model 53.

As in the case of the RP model 53, many tracer particles 56 are dispersed in the stirred solution 52. The laser light having entered the stirred solution 52 is diffracted by the many tracer particles 56 inside the RP model 53, so that a first laser light having been diffracted and a second laser light not having been diffracted exit from the stirred solution 52. In this case, the second laser light not having been diffracted serves as reference light. As a result, the reference light and object light which is the first laser light having been diffracted interfere with each other. The reference light and the object light are used for tracing a displacement of a tracer particle 56 inside the stirred solution 52. The following description refers to the reference light and the object light each of which is used for tracing a displacement of a tracer particle 56 inside the stirred solution 52 as “stirred solution reference light” and “stirred solution object light”, respectively.

The laser light having exited from the stirred solution 52, i.e., each of the stirred solution object light and the stirred solution reference light passes through the side wall of the sealed container 51, the refractive index matching solution 22, and the side wall of the retaining section 20 in this order and then enters the second optical system 13. Note that a part of each of the stirred solution object light and the stirred solution reference light may be diffracted again by a tracer particle inside the RP model 53. In this case, light thus diffracted is not used for tracing a displacement of a tracer particle inside the stirred solution 52.

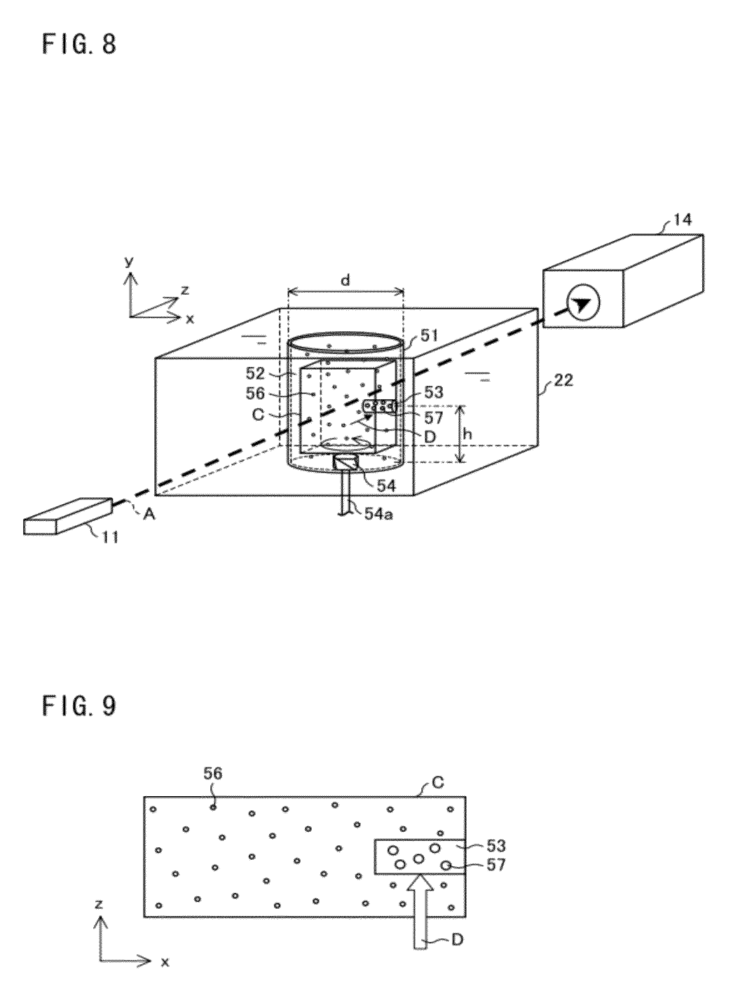

The stirring member 54 stirs the stirred solution 52. The stirring member 54 rotates like a spinning top, so as to cause a flow in accordance with a direction of the rotation in the stirred solution 52. In the case of FIG. 7, the stirring member 54 can cause a clockwise or counterclockwise flow in an x-z plane in the stirred solution 52. According to this, the clockwise or counterclockwise flow occurs in the stirred solution 52 as described above. As a result, a part of the stirred solution 52 collides with the RP model 53. The collision applies a load to the RP model 53 as in the case of the application of the load to the RP model 21 by the load application mechanism 31 and the load application mechanism 32 in the First Embodiment. In the case of FIG. 7, when the stirring member 54 rotates clockwise or counterclockwise in the x-z plane, a load in a direction (direction of an arrow indicated by D in FIG. 8) parallel to the x-z plane is applied to the RP model 53.

Namely, it can be said that the flow caused by the stirring member 54 in the stirred solution 52 serves as a load application mechanism which applies a load to the RP model 53.

The stirring member 54 includes, for example, a support rod 54a which extends toward an outside of the retaining section 20. The support rod 54a is connected to a drive circuit 55. The drive circuit 55 drives the rotation by the stirring member 54 (described earlier) by causing the support rod 54a to rotate. A drive operation of the drive circuit 55 is controlled by the control circuit 15a (described later).

According to the stress measurement device 100a, the camera 14 records images of (i) the RP model reference light and the RP model object light (described earlier), and (ii) the stirred solution reference light and the stirred solution object light (described earlier), respectively. Namely, image data of the RP model reference light and the RP model object light, the image data having been recorded by the camera 14, is supplied to the image processing device 40, in which a movement distance and a movement direction of a tracer particle inside the RP model 53 are found in accordance with such image data. In contrast, image data of the stirred solution reference light and the stirred solution object light, the image data having been recorded by the camera 14, is supplied to the image processing device 40, in which a movement distance and a movement direction of a tracer particle 56 inside the stirred solution 52 are found in accordance with such image data.

The RP model object light and the RP model reference light each of which is the laser light having exited from the RP model 53 interfere with each other. As a result, the camera 14 records digital holographic images of the respective many tracer particles inside the RP model 53.

The camera 14 records, as, for example, digital data, the digital holographic images thus recorded, so as to supply the digital data to the image processing device 40.

The image processing device 40 carries out a three-dimensional image process in accordance with the digital holographic images recorded by the camera 14. For each of the many tracer particles inside the RP model 53, an analyzing section 41 carries out a three-dimensional PIV analysis with respect to the digital holographic images recorded by the camera 14.

In accordance with the three-dimensional PIV analysis carried out by the analyzing section 41, the image processing device 40 finds, from, for example, the digital holographic images recorded at a time t0, three-dimensional positions of the respective many tracer particles at the time t0. Similarly, the image processing device 40 finds, from, for example, the digital holographic images recorded at a time t0+Δt, three-dimensional positions of the respective many tracer particles at the time t0+Δt. Velocity vectors of the respective many tracer particles can be found by dividing, by Δt, a difference in three-dimensional position at each time.

The image processing device 40 uses the velocity vectors thus found of the respective many tracer particles inside the RP model 53 to measure a change over time in stress field inside the RP model 53 from the time t0 to the time t0+Δt.

Similarly, the stirred solution object light and the stirred solution reference light each of which is the laser light having exited from the stirred solution 52 interfere with each other. As a result, the camera 14 records digital holographic images of the respective many tracer particles 56 inside the stirred solution 52.

The camera 14 records, as, for example, digital data, the digital holographic images thus recorded, so as to supply the digital data to the image processing device 40.

The image processing device 40 carries out a three-dimensional image process in accordance with the digital holographic images recorded by the camera 14. For each of the many tracer particles 56 inside the stirred solution 52, the analyzing section 41 carries out a three-dimensional PIV analysis with respect to the digital holographic images recorded by the camera 14.

In accordance with the three-dimensional PIV analysis carried out by the analyzing section 41, the image processing device 40 finds, from, for example, the digital holographic images recorded at a time t0, three-dimensional positions of the respective many tracer particles 56 at the time t0. Similarly, the image processing device 40 finds, from, for example, the digital holographic images recorded at a time t0+Δt, three-dimensional positions of the respective many tracer particles 56 at the time t0+Δt. Velocity vectors of the respective many tracer particles 56 can be found by dividing, by Δt, a difference in three-dimensional position at each time.

The image processing device 40 uses the velocity vectors thus found of the respective many tracer particles 56 inside the stirred solution 52 to measure a change over time in velocity field inside the stirred solution 52 from the time t0 to the time t0+Δt.

The control device 15a is electrically connected to each of the light source 11, the camera 14, and the drive circuit 55 so that various control signals can be exchanged between the control device 15a and each of the light source 11, the camera 14, and the drive circuit 55. The control device 15 controls, for example, a drive operation of the light source 11, an image recording operation of the camera 14, and the drive operation of the drive circuit 55.

It is only necessary that the control device 15 synchronize, for example, a timing at which the laser light from the light source 11 is emitted, a timing at which the drive circuit 55 drives the stirring member 54, and a timing at which the camera 14 carries out image recording.

(Stirred Solution 52 and RP Model 53)

Next, the following description discusses the stirred solution 52 and the RP model 53. FIG. 8 is a conceptual view for describing the stirred solution 52 and the RP model 53. In FIG. 8, for viewability of the drawing, only an optical path of laser light emitted from the light source 11 is shown by an arrow indicated by A in FIG. 8. Note that an area indicated by C in FIG. 8 is a region of the stirred solution 52 and the RP model 53 to which region the laser light emitted from the light source 11 is directed.

Many tracer particles 57 are dispersed in the RP model 53 (see FIG. 8). A type, etc. of a tracer particle 57 is not particularly limited in the present invention. The type, etc. is appropriately selected in accordance with a type, etc. of a photoelastic material of which the RP model 53 is made.

As described earlier, the RP model 53 is fixed to the inner wall of the sealed container 51, and the sealed container 51 is filled with the stirred solution 52. In other words, the stirred solution 52 surrounds the RP model 53 (see FIG. 8).

The stirred solution 52 has a refractive index which matches a refractive index of the photoelastic material of which the RP model 53 is made. Specifically, the stirred solution 52 is substantially identical in refractive index to the photoelastic material of which the RP model 53 is made. In view of this, it can be said that the stirred solution 52 has a function which is identical to a function of the refractive index matching solution that surrounds the RP model 21 in the First Embodiment.

Note that, in a case where the photoelastic material of which the RP model 53 is made and the stirred solution 52 differ in refractive index by approximately 1%, it can be said that the photoelastic material of which the RP model 53 is made and the stirred solution 52 are substantially identical in refractive index.

In a case where the RP model 53 and the stirred solution 52 are identical in refractive index, a difference in refractive index at a boundary between the RP model 53 and the stirred solution 52 can be resolved.

This prevents the laser light emitted from the light source 11 from being refracted at the boundary between the stirred solution 52 and the RP model 53 when the laser light passes through the stirred solution 52 and the RP model 53 in this order.

Further, neither the RP model object light having been diffracted by the many tracer particles 57 inside the RP model 53 nor the RP model reference light not having been diffracted by the many tracer particles 57 is refracted at the boundary between the RP model 53 and the stirred solution 52 when the RP model object light and the RP model reference light enters the stirred solution 52 from the RP model 53.

Accordingly, the laser light emitted from the light source 11 enters the RP model 53 without being refracted at the boundary between the stirred solution 52 and the RP model 53. Then, each of the RP model object light having been diffracted inside the RP model 53 and the RP model reference light enters the stirred solution 52 without being refracted at the boundary between the stirred solution 52 and the RP model 53.

Therefore, the camera 14 can accurately record an image of each of the RP model object light having been diffracted by the many tracer particles 57 inside the RP model 53 and the RP model reference light not having been diffracted by the many tracer particles 57.

As the RP model 53 has a more complicated shape, a difference in refractive index between the RP model 53 and its surroundings causes the laser light which passes through a boundary between the RP model 53 and its surroundings to be more highly refracted. This increases a degree with which the camera 14 is prevented from accurately carrying out image recording.

Also according to the stress measurement device 100a in accordance with the Second Embodiment of the present invention, the above problems can be solved by causing the stirred solution 52 which is identical in refractive index to the RP model 53 to surround the RP model 53.

Note that according to the Second Embodiment, the sealed container 51 is contained in the retaining section 20, which is filled with the refractive index matching solution 22. That is, the refractive index matching solution 22 surrounds the sealed container 51 (see FIG. 8).

Therefore, the refractive index matching solution has a refractive index which matches a refractive index of a light-transmissive transparent material of which the sealed container 51 is made. For example, in a case where the sealed container 51 and the RP model 53 are made of a single photoelastic material, it is only necessary that the refractive index matching solution 22, the sealed container 51, the stirred solution 52, and the RP model 53 be substantially identical in refractive index. Since an effect yielded by the refractive index matching solution 22 and the sealed container 51 which are identical in refractive index is identical to an effect yielded by the stirred solution 52 and the RP model 53 which are identical in refractive index, a description thereof is not repeated here.

(Example)

Next, the following description discusses an example of the stirred solution 52 and the RP model 53. FIG. 9 is a cross-sectional view showing a specific example of (a part of) the stirred solution 52 and the RP model 53.

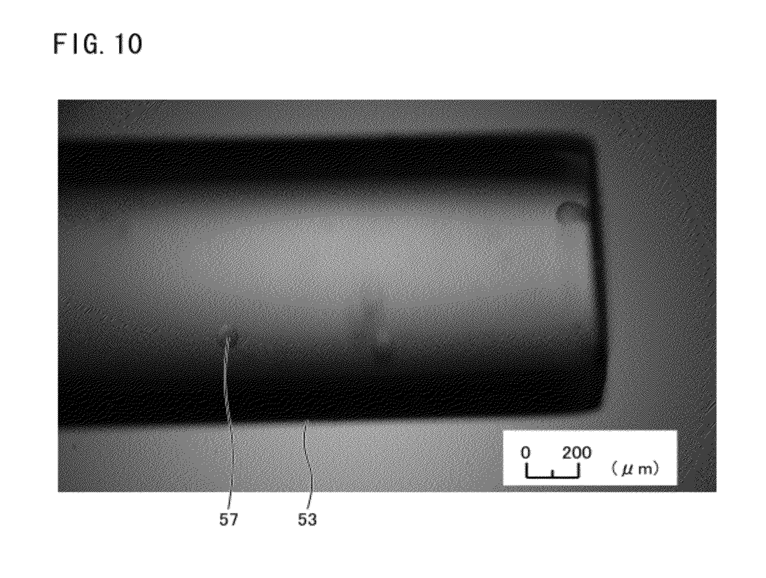

In the example shown in FIG. 9, the RP model 53 is made of a light-transmissive acrylic resin (refractive index: 1.4883, elastic coefficient: 3317 Mpa). The light-transmissive acrylic resin has a cylindrical shape, a cross section whose diameter is 2 mm, and a length of 11.5 mm. The many tracer particles 57 dispersed in the RP model 53 have an average diameter of 100 μm. FIG. 10 illustrates the many tracer particles 57 dispersed in the RP model 53.

Note that the sealed container 51 which is fixed to the inner wall of the RP model 53 has a cylindrical shape, and has a cross section whose diameter (diameter of the inner wall) is 41 mm (see FIG. 8). The RP model 53 is fixed at a height h of 20 mm from a bottom of the sealed container 51.

As in the case of the refractive index matching solution 22, the stirred solution 52 is a sodium iodide solution which is identical in refractive index to the acrylic resin of which the RP model 53 is made. The stirred solution 52 has a kinematic viscosity coefficient (dynamic viscosity) of 1.365 mm/sec² at 30.4° C. The many tracer particles 56 dispersed in the stirred solution 52 have an average diameter of 60 μm.

Note that an area indicated by C in each of FIGS. 8 and 9 is a region of the stirred solution 52 and the RP model 53 to which region the laser light emitted from the light source 11 is directed. The region has a size of 30.72×30.72×6.0 mm².

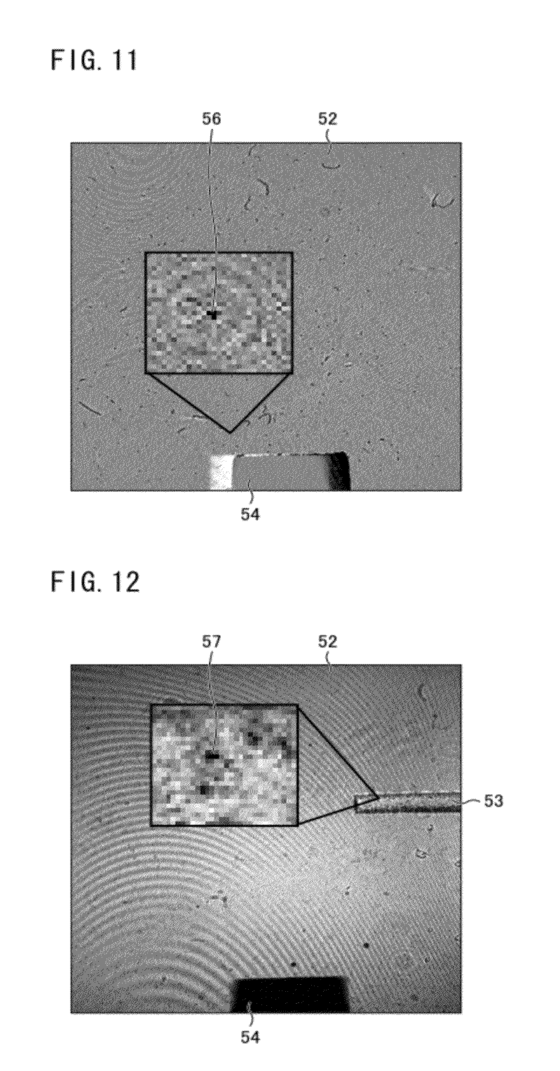

FIG. 11 illustrates image data of the stirred solution reference light and the stirred solution object light, the image data having been recorded by the camera 14. An image of a tracer particle 56 inside the stirred solution 52 has been recorded (see FIG. 11).

FIG. 12 illustrates image data of the RP model reference light and the RP model object light, the image data having been recorded by the camera 14. An image of a tracer particle 57 inside the RP model 53 has been recorded (see FIG. 12).

Note that according to the stress measurement device 100a, a change over time in three-dimensional stress in the RP model 53 and a change over time in three-dimensional velocity of the stirred solution 52 are measured concurrently (described earlier). Accordingly, it is necessary to discriminate between the tracer 56 and the tracer 57 and record images of the tracer 56 and the tracer 57, respectively. Therefore, for example, use of a particle mask correlation method allows discrimination between the tracer 56 and the tracer 57 and recording of images of the tracer 56 and the tracer 57, respectively, the particle mask correlation method being specifically described in, for example, “PIV handbook” by The Visualization Society of Japan, published by Morikita Publishing Co., Ltd., Jul. 20, 2002.

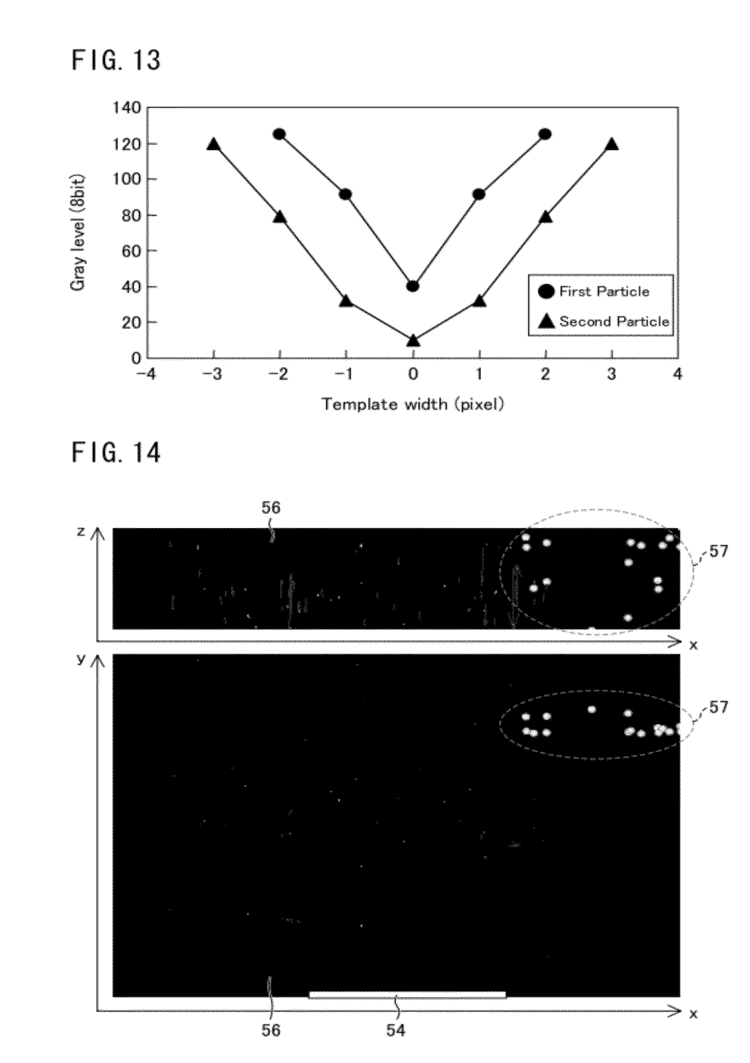

According to the particle mask correlation method, ideal particle images of the tracer 56 and the tracer 57, respectively, are prepared as their respective templates in advance. By use of the respective templates, regions which are similar to the respective templates are extracted as particle images of the tracer 56 and the tracer 57, respectively, from image data in which particle images of the tracer 56 and the tracer 57, respectively, are mixed. FIG. 13 shows template widths of the tracer 56 and the tracer 57, respectively. In the case of FIG. 13, the tracer particle 56 (first particle) inside the stirred solution 52 has a template width of −2 pixels to 2 pixels, whereas the tracer particle 57 (second particle) inside the RP model 53 has a template width of −3 pixels to 3 pixels.

According to the Second Embodiment, since the tracer particle 56 and the tracer particle 57 have different particle sizes, it is possible to discriminate between the tracer 56 and the tracer 57 and record images of the tracer particle 56 and the tracer particle 57, respectively (described earlier).

FIG. 14 illustrates (i) image data in which the region indicated by C in each of FIGS. 8 and 9 is seen from a y direction and (ii) image data in which the region indicated by C is seen from a z direction. Images of the tracer particle 56 inside the stirred solution 52 and the tracer particle 57 inside the RP model 53, respectively, have been recorded as illustrated in FIG. 14.

The present invention is not limited to the description of the embodiments above, but may be altered by a skilled person within the scope of the claims. An embodiment based on a proper combination of technical means disclosed in different embodiments is encompassed in the technical scope of the present invention.

A stress measurement device in accordance with the present invention in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding, the stress measurement device includes: a retaining section which retains the light-transmissive member while soaking the light-transmissive member in a refractive index matching solution having a refractive index that matches a refractive index of the light-transmissive member; and a load application mechanism which applies a load to the light-transmissive member retained by the retaining section.

Note here that the application of the load to the light-transmissive member by the “load application mechanism” realizes, in the light-transmissive member, a distribution of various stresses such as a compressive stress, a shearing stress, and a bending stress.

According to the stress measurement device, it is possible to apply the load to the light-transmissive member while soaking, in the refractive index matching solution having a refractive index that matches a refractive index of the light-transmissive member, the light-transmissive member which is subjected to a stress measurement.

This makes it possible to measure the three-dimensional stress in the light-transmissive member to which the load is applied while preventing refraction of light at a boundary between the light-transmissive member and the refractive index matching solution. Therefore, a change over time in three-dimensional stress in the light-transmissive member can be measured with high accuracy.

It is preferable that the light-transmissive member and the refractive index matching solution be substantially identical in refractive index.

In this case, even if the light-transmissive member has a complicated shape, it is possible to effectively prevent refraction of light at the boundary between the light-transmissive member and the refractive index matching solution, so that a change over time in three-dimensional stress in the light-transmissive member can be measured with high accuracy.

Note here that the term “identical” in “identical in refractive index” encompasses not only a case of perfect matching but also a case of substantially perfect matching. Specifically, in a case where the light-transmissive member and the refractive index matching solution differ in refractive index by approximately 1%, it can be said that the light-transmissive member and the refractive index matching solution are identical in refractive index.

It is preferable that the plurality of particles be uniformly dispersed in the light-transmissive member.

In this case, the three-dimensional stress in the light-transmissive member can be measured with higher accuracy.

Note here that the term “uniformly” in “uniformly dispersed” encompasses not only a case of perfect uniformity but also a case of substantial uniformity.

It is preferable that the plurality of particles be dispersed in the light-transmissive member so as to be locally concentrated in a part of the light-transmissive member which part is to be measured by the stress measurement device.

In this case, since many particles are dispersed in the part to be measured, the part can be measured with higher accuracy.

It is preferable that the light-transmissive member be a rapid prototyping model formed by use of rapid prototyping in accordance with a three-dimensional CAD model for designing a complicated shape of a product.

In this case, a conventional rapid prototyping device can be used.

A stress measurement method in accordance with the present invention in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding, the stress measurement method includes the steps of: (a) retaining the light-transmissive member while soaking the light-transmissive member in a refractive index matching solution having a refractive index that matches a refractive index of the light-transmissive member; and (b) measuring a change over time in three-dimensional stress occurring in the light-transmissive member, while applying a load to the light-transmissive member soaked in the refractive index matching solution.

According to the stress measurement method, it is possible to apply the load to the light-transmissive member while soaking, in the refractive index matching solution having a refractive index that matches a refractive index of the light-transmissive member, the light-transmissive member which is subjected to a stress measurement.

This makes it possible to measure the three-dimensional stress in the light-transmissive member to which the load is applied while preventing refraction of light at a boundary between the light-transmissive member and the refractive index matching solution. Therefore, a change over time in three-dimensional stress in the light-transmissive member can be measured with high accuracy.

It is preferable that: the load application mechanism be a stirred solution which (i) is stirred while the light-transmissive member is entirely soaked therein and (ii) serves as the refractive index matching solution; and a plurality of particles which differ in particle size from the plurality of particles dispersed in the light-transmissive member be dispersed in the stirred solution, and the stress measurement device measure the three-dimensional stress occurring in the light-transmissive member to which the load is applied by the stirring of the stirred solution.

In this case, it is possible to measure the three-dimensional stress occurring in the light-transmissive member to which the load is applied by the stirring of the stirred solution which is a fluid.

This makes it possible to measure a change over time in three-dimensional stress in an RP model in a three-dimensional space in which the RP model that is a structure and a stirred solution that is a fluid exist concurrently and interact with each other.

It is preferable that further in the stress measurement device, image processing be carried out with respect to each of the plurality of particles dispersed in the stirred solution to which light is emitted, movement directions and movement amounts of the respective plurality of particles in the stirred solution be found, and a three-dimensional velocity of the stirred solution be measured by use of a result of the finding.

In this case, a change over time in three-dimensional stress in an RP model and a change over time in three-dimensional velocity of a stirred solution can be measured concurrently.

The stress measurement method is preferably arranged such that: the load be applied to the light-transmissive member by stirring the stirred solution while entirely soaking the light-transmissive member in the stirred solution, and the stirred solution serve as the refractive index matching solution; and a plurality of particles which differ in particle size from the plurality of particles dispersed in the light-transmissive member be dispersed in the stirred solution.

In this case, it is possible to measure the three-dimensional stress occurring in the light-transmissive member to which the load is applied by the stirring of the stirred solution which is a fluid.

This makes it possible to measure a change over time in three-dimensional stress in an RP model in a three-dimensional space in which the RP model that is a structure and a stirred solution that is a fluid exist concurrently and interact with each other.

### INDUSTRIAL APPLICABILITY

The present invention is suitable for a stress measurement device and a stress measurement method in each of which a change over time in three-dimensional stress field in an RP model formed by use of three-dimensional CAD and RP is measured in accordance with three-dimensional holographic PIV or three-dimensional stereo PIV. Further, the present invention can be suitably used for a stress measurement device and a stress measurement method in each of which a change over time in three-dimensional stress in the RP model and a change over time in three-dimensional velocity of a fluid are measured concurrently in a three-dimensional space in which the RP model and the fluid exist concurrently. In addition, the present invention is suitable for a stress measurement device and a stress measurement method in each of which changes over time in three-dimensional stress in respective two or more RP models are measured concurrently in a three-dimensional space in which the two or more RP models interact with each other.

### REFERENCE SIGNS LIST

11 Light source
12 First optical system
13 Second optical system
14 Camera
15, 15a Control device
20 Retaining section
21, 53 RP model (Light-transmissive member)
22 Refractive index matching solution
23 Tracer particle (Particle)
31, 32 Load application mechanism
   40 Image processing device
41 Analyzing section
51 Sealed container
51 Stirred solution
54 Stirring member
55 Drive circuit
100, 100a Stress measurement device

1. A stress measurement device in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding,
the plurality of particles being irregularly dispersed in no particular direction in the light-transmissive member,
said stress measurement device comprising:
a retaining section which retains the light-transmissive member while soaking the light-transmissive member in a refractive index matching solution having a refractive index that matches a refractive index of the light-transmissive member; and
a load application mechanism which applies a load to the light-transmissive member retained by the retaining section.

2. The stress measurement device as set forth in claim 1, wherein the light-transmissive member and the refractive index matching solution are identical in refractive index.

3. The stress measurement device as set forth in claim 1, wherein the plurality of particles are unifoimly dispersed in the light-transmissive member.

4. The stress measurement device as set forth in claim 1, wherein the plurality of particles are dispersed in the light-transmissive member so as to be locally concentrated in a part of the light-transmissive member which part is to be measured by the stress measurement device.

5. The stress measurement device as set forth in claim 1, wherein the light-transmissive member is a rapid prototyping model formed by use of rapid prototyping in accordance with a three-dimensional CAD model for designing a complicated shape of a product.

6. A stress measurement method in which image processing is carried out with respect to each of a plurality of particles dispersed in a light-transmissive member to which light is emitted, movement directions and movement amounts of the respective plurality of particles in the light-transmissive member are found, and a three-dimensional stress occurring in the light-transmissive member is measured by use of a result of the finding,
the plurality of particles being irregularly dispersed in no particular direction in the light-transmissive member,
said stress measurement method comprising the steps of:
(a) retaining the light-transmissive member while soaking the light-transmissive member in a refractive index matching solution having a refractive index that matches a refractive index of the light-transmissive member; and
(b) measuring a change over time in three-dimensional stress occurring in the light-transmissive member, while applying a load to the light-transmissive member soaked in the refractive index matching solution.

7. The stress measurement device as set forth in claim 1, wherein:
the load application mechanism is a stirred solution which (i) is stirred while the light-transmissive member is entirely soaked therein and (ii) serves as the refractive index matching solution; and
a plurality of particles which differ in particle size from the plurality of particles dispersed in the light-transmissive member are dispersed in the stirred solution, and the stress measurement device measures the three-dimensional stress occurring in the light-transmissive member to which the load is applied by the stirring of the stirred solution.

8. The stress measurement device as set forth in claim 7, wherein further in the stress measurement device, image processing is carried out with respect to each of the plurality of particles dispersed in the stirred solution to which light is emitted, movement directions and movement amounts of the respective plurality of particles in the stirred solution are found, and a three-dimensional velocity of the stirred solution is measured by use of a result of the finding.

9. The stress measurement method as set forth in claim 6, wherein:
the load is applied to the light-transmissive member by stirring the stirred solution while entirely soaking the light-transmissive member in the stirred solution, and the stirred solution serves as the refractive index matching solution; and
a plurality of particles which differ in particle size from the plurality of particles dispersed in the light-transmissive member are dispersed in the stirred solution.
